(19) United States
(12) Patent Application Publication
(10) Pub. No.: US 2004/0163545 A1
(43) Pub. Date: Aug. 26, 2004

(54) Coffee machine having a grounds-compressing piston

(75) Inventor: John Duncan McNair, Olinda (AU)

Correspondence Address: LEYDIG VOIT & MAYER, LTD, 700 THIRTEENTH ST. NW, SUITE 300, WASHINGTON, DC, 20005-3960, US

(73) Assignee: Chiaphua Industries Limited, Tai Po (HK)

(21) Appl. No.: 10/372,290

(22) Filed: Feb. 25, 2003

(51) Int. Cl. A47J 31/00

(52) U.S. Cl. 99/279

(57) ABSTRACT

A coffee machine has a space for receiving coffee grounds. Pressurised fluid is forced into the space. There is a filter screen against which the coffee grounds bear in use and through which coffee-infused fluid from the space passes to be dispensed. A fluid-pervious piston is located within the space and moves toward the filter screen to thereby compress the coffee grounds in use. This prevents the coffee grounds from separating from one another in which case the pressurised fluid might take a path of least resistance, not necessarily an infusion path through the grounds.

### BACKGROUND OF THE INVENTION

The present invention relates to a coffee making device. More particularly, although not exclusively, the invention relates to a coffee making device having a piston for compressing coffee grounds through which steam passes en route to dispensation.

Espresso machines and other machines for preparing coffee by passing steam or hot water under pressure through coffee grounds are known.

In practice, coffee grounds are compressed manually into a cradle prior to or after attachment of the cradle to the machine body. Pressurised steam or hot water that is forced through the compressed coffee grounds will naturally tend to take the path of least resistance en route through the grounds to be dispensed. A satisfying coffee with a good creamer can only be achieved where the steam or water maintains good contact with the coffee grounds during this process. However, it has been found that the grounds tend to decompress and separate from one another after commencement of steam/water flow, allowing an easy path for the steam or water to escape through interstices between the grounds, thereby diminishing the coffee-infusion efficiency and resulting in poor coffee.

### OBJECTS OF THE INVENTION

It is an object of the present invention to overcome or substantially ameliorate the above disadvantage and/or more generally to provide improved coffee making device.

### DISCLOSURE OF THE INVENTION

There is disclosed herein a coffee machine comprising:

a space for receiving coffee grounds,

means forcing pressurised fluid into the space,

a filter screen against which the coffee grounds bear in use and through which coffee-infused fluid from the space passes to be dispensed, and

a fluid-pervious piston located within the space and movable toward the filter screen to thereby compress the coffee grounds in use.

Preferably the fluid-pervious piston is biased toward the filter screen by the pressurised fluid.

Preferably the coffee machine comprises a main body and the space is provided by a cradle secured to the main body.

Preferably the cradle is cylindrical.

Preferably the piston is circular and received loosely within the cradle.

Preferably the main body is a pressure vessel into which the cradle is received and the machine comprises a lid secured to the pressure vessel and to which the filter screen is attached.

Preferably the cradle bears against the filter screen.

Preferably the piston includes a seal about its periphery.

### BRIEF DESCRIPTION OF THE DRAWINGS

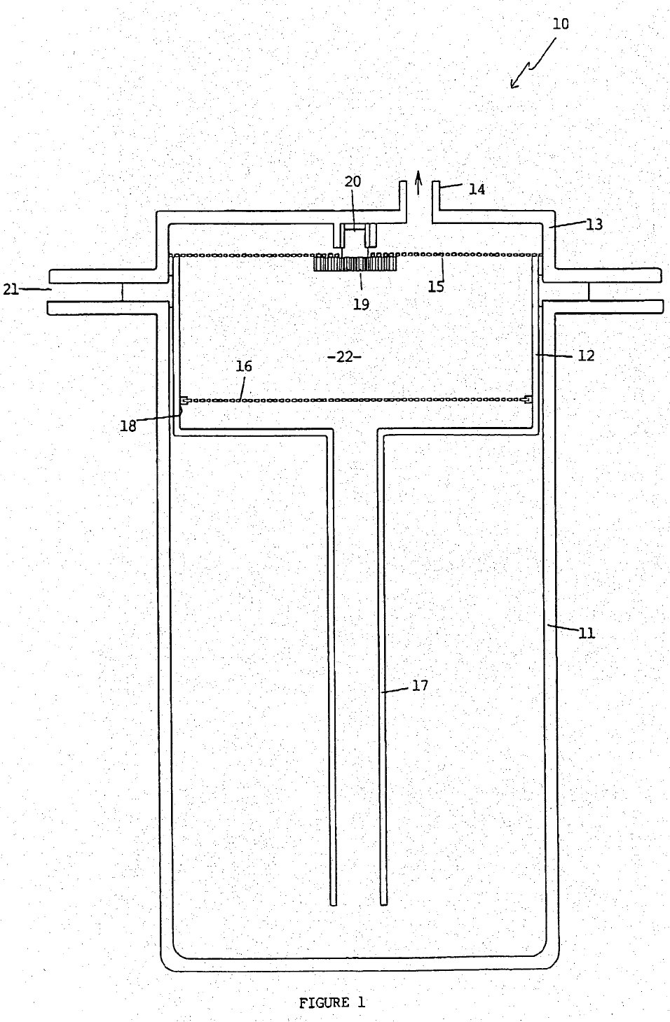

A preferred form of the present invention will now be described by way of example with reference to FIG. 1, which is a schematic cross-sectional elevational view of components of a coffee-making machine.

### DESCRIPTION OF THE PREFERRED EMBODIMENT

In the accompanying drawing there are depicted schematically components 10 of a coffee-making machine, the shell and cosmetic parts of which are omitted for clarity.

A pressure vessel 11 has affixed thereto a cover 13. Both of these components might be made from cast aluminium or machined from stainless steel or other strong material. Although some high-grade plastics material might be employed, aluminium is the preferred material. At region 21, there might be a bayonet clamp, a threaded interengagement or any other means of securely interconnecting the cover and vessel. The vessel 11 and cover 13 are typically circular when viewed from above.

Situated within the top part of the vessel 11 is a cradle 12 having a dip tube 17 extending downwardly therefrom toward the bottom of the vessel 11. The cradle would also be circular when viewed from above. Within the cradle 12, there is a space 22 for receiving coffee grounds.

Secured within the cover 13 by a bolt 19 having thread 20 is a filter screen 15. The cover has a liquid coffee outlet port 14 above the filter screen 15. The filter screen 15 might be formed from a sheet of stainless steel for example with perforations made therein.

Alternatively, the filter screen might be gauze. Either way, the perforations or “mesh” are to be sufficiently small as to allow the passage therethrough of coffee-infused liquid, but not coffee grounds.

There is located within the cradle 12 a piston 16 having a seal or guide ring 18 thereabout. The piston 18 is to be slidably received within the cradle 12 so as to be movable vertically. The piston might comprise a perforated metallic plate or might alternatively be gauze. The perforation size of the plate or the “mesh” of the gauze is to be sufficiently large to allow the passage of liquid into the space 22, but not so large as to allow coffee grounds from the space 22 to pass in the reverse direction therethrough.

In use, water is poured into the vessel 11. The piston 16 is placed inside the cradle 12 and coffee grounds are then placed and/or compressed upon the piston 16 to fill the space 22. The cradle can then be placed in the top part of the vessel 11. Alternatively, the cradle 12 can be inserted into the top of the vessel 11 and the piston 16 then placed in the cradle prior to feeling the space 22 with coffee grounds The cover 13 having the filter screen 15 attached thereto by means of bolt 19 is then secured to the vessel. Heat is applied to the vessel exterior. This might be by way of a naked flame or an electric heater for example. As the water within vessel 11 boils, steam and/or hot water travels upwardly through the dip tube 17 and pressure is applied against the under-surface of the piston 16. The coffee grounds become infiltrated with steam and/or water as the same passes upwardly together with entrained coffee flavour through the filter screen 15 and the outlet port 14. The outlet port 14 might hare an extension tube passing upwardly into the middle of a coffee-receiving vessel mounted upon the cover 13 or elsewhere.

Instead of creating an inefficient through-path through the coffee grounds within space 22 as might occur upon expansion of the coffee Grounds to form interstices therebetween, the piston 16 continuously bears upwardly upon the coffee grounds to maintain a compressed state through which the steam and or water must force en route to the outlet port 14.

It should be appreciated that modifications and alterations obvious to those skilled in the art are not to be considered as beyond the scope of the present invention. For example, in addition to the application of steam pressure force to the under-surface of the piston 16, there might be an additional mechanical spring or springs biasing the piston upwardly against the coffee grounds in space 22. Furthermore, the apparatus might be inverted such that the piston 16 bears downwardly upon the coffee grounds within space 22. This would be applicable in commercial espresso machines as used in restaurants and cafes where a handled cradle is bayonet-fitted upwardly to a downwardly facing attachment. In such inverted situations the filter screen is formed integrally with the cradle i.e. the inside bottom perforated surface of the coffee grounds-receiving space and the piston 16 might be made hear to assist in maintaining compaction of the coffee ground against the filter screen from above. In this commercial situation, or for smaller scale domestic machines where a coffee cup is placed under the coffee outlet, the coffee grounds could be pressed into the handled cradle and the piston then placed thereon prior to attachment to the machine.

1. A coffee machine comprising:
a space for receiving coffee grounds,
means forcing pressurised fluid into the space,
a filter screen against which the coffee grounds bear in use and through which coffee-infused fluid from the space passes to be dispensed, and
a fluid-pervious piston located within the space and movable toward the filter screen to thereby compress the coffee grounds in use.

2. The machine of claim 1, wherein the fluid-pervious piston is biased toward the filter screen by the pressurised fluid.

3. The machine of claim 1 further comprising a main body and wherein the space is provided by a cradle secured to the main body.

4. The machine of claim 3 wherein the cradle is cylindrical.

5. The machine of claim 3 wherein the piston is circular and received loosely within the cradle.

6. The machine of claim 3 wherein the main body comprises a pressure vessel into which the cradle is received and the machine comprises a lid secured to the pressure vessel and to which the filter screen is attached.

7. The machine of claim 3 wherein the cradle bears against the filter screen.

8. The machine of claim 1 wherein the piston includes a seal about its periphery.
